(19) United States
(12) Patent Application Publication
(10) Pub. No.: US 2002/0021782 A1
(43) Pub. Date: Feb. 21, 2002

(54) Optical assembly for increasing the intensity of a formed X-ray beam

(76) Inventor: William T. McDonald, Hoover, AL (US)

Correspondence Address: HARNESS, DICKEY & PIERCE, PLC, P.O. BOX 828, BLOOMFIELD HILLS, MI, 48303, US

(21) Appl. No.: 09/820,287

(22) Filed: Mar. 28, 2001

Related U.S. Application Data
(60) Provisional application No. 60/194,220, filed on Apr. 3, 2000.

(51) Int. Cl. G02B 5/124

(52) U.S. Cl. 378/84; 250/505.1; 378/145

(57) ABSTRACT

An x-ray optical assembly for increasing the intensity of a formed x-ray beam. The optical assembly includes a capillary type optical device and an x-ray reflective mirror device configured and aligned to provide a desirable x-ray crystallography beam. An x-ray beam from an x-ray source enters the individual capillaries of the capillary optical device, where the exit beam intensity is increased. The beam exits the capillary optical device at a particular convergent or divergent angle, and is directed into the mirror device. The mirror device either focuses or collimates the beam to have a small convergent or divergent angle suitable for the sample being analyzed. The mirror device can be any suitable device known in the art, such as a grazing incidence flat mirror device, a grazing incidence bent mirror device, a grazing incidence shaped mirror device or a graded multilayer mirror device.

### CROSS REFERENCE TO RELATED APPLICATIONS

This Application claims priority of U.S. Provisional Application No. 60/194,220, titled Optical Assembly for an X-ray Diffraction Crystallography System, filed Apr. 3, 2000.

### GOVERNMENT RIGHTS

The Government may have certain rights in this invention pursuant to grant no. NAGW-813, entitled “Center for Macromolecular Crystallography, Center for the Commercial Development of Space” issued by NASA.

### BACKGROUND OF THE INVENTION

1. Field of the Invention

This invention relates generally to an optical assembly suitable for increasing the intensity of a formed x-ray beam and, more particularly, to an optical assembly suitable for increasing the intensity of a formed beam that includes a combination of a capillary type optical device and an x-ray reflective mirror device, and has particular application for x-ray diffraction of crystals.

2. Discussion of the Related Art

X-ray diffraction crystallography is a well known technique for determining the structure of crystal molecules. In x-ray crystallography, an x-ray beam is directed towards a sample to be analyzed, and x-rays diffracted by and reflected from the sample are detected by a suitable detection array, such as a CCD array. The location of the reflected x-rays on the detector array are used to determine the structure of the crystal molecules.

In x-ray crystallography, it is desirable that the dimensions of the x-ray beam impinging the sample be on the order of the sample size, or on the order of a location on the sample that is being examined. Additionally, the intensity of the x-ray beam should be as consistent as possible across the sample. Also, it is desirable that the intensity of the x-ray beam be high enough so that the detection time of the sample be reasonable. For single crystal diffraction of protein crystals, an x-ray beam is required which has the following critical features: (1) monochromaticity (typically at the copper K-alpha wavelength, 1.5418 Angstroms); (2) low angular divergence or convergence (less than 1.0 milliradian full cone angle); and (3) high peak flux level (x-ray photons per square millimeter per second).

A known instrument which provides an x-ray beam satisfying all the above requirements is the synchroton. However, synchrotons are not available to most crystallographers. Laboratory-type diffraction systems are therefore necessary. Current laboratory systems satisfy the monochromaticity requirement, but provide beams with only marginal angular divergence or convergence and beam flux levels much less than synchrotron x-ray beams. A basic limitation to both beam collimation (i.e., angular divergency or convergency) and flux level are the x-ray beam forming optical assemblies that are available for laboratory diffraction systems.

The known art of x-ray beam forming optics suitable for diffraction crystallography includes various types of optical devices. These optical devices gather x-ray photons from an x-ray source (typically a rotating anode source or an electron tube source), form the x-ray beam, and direct the beam onto the crystal target or sample. An x-ray source typically generates a very large number of x-rays, but the optical device can collect only a small percentage of those x-rays because of geometrical limits imposed by the beam forming optics. In general, the overall performance of the x-ray generating sub-system in a laboratory-type x-ray diffraction system is limited by (1) the geometrical limitation of available x-rays from the source that the optical device is capable of accepting, (2) the x-ray transmission efficiency of the optical device, (3) the capability of the optical device to suitably collimate the beam, and (4) transmission losses in a monochromator device necessary in the optical path between the x-ray source and the target crystal. The principal efforts in the prior art have been directed to improving the fraction of x-rays accepted, the transmission efficiency, and the beam collimation capability of the optical device.

At present, the x-ray generating sub-systems provide x-ray beams with usable flux in the range of 10⁸ to 10⁹ x-ray photons per square millimeter per second at the target crystal location. A major advantage of providing an increase in beam flux is a decrease of the same magnitude in the time required to acquire a complete diffraction data set for a single crystal. This is very important from an equipment utilization standpoint because protein crystals are labile, and thus will decay with time unless cryogenically frozen.

TABLE 1
Advanced Optics Comparison

| | | | Beam Collimation or | |
|---|---|---|---|---|
| Optics Type | X-Ray Collection Factor | Beam Steering Capability | Focusing | Monochromator |
| Pinhole collimator | 1.0 - basis for comparison | None | Collimation only | No |
| Grazing incidence mirrors | ˜3 | ≈0.5 deg | No | No |
| Flat | | ≈1.0 deg | Yes (limited) | No |
| Bent | | | | |
| Shaped grazing incidence | >150 | No | Both | No |
| mirrors | | | | |
| Graded multilayer mirrors | ˜100 | No | Both | Yes |
| Capillary (Kumakov) optics | ˜1000** | Yes (few deg) | Both, but crude | No |
| | | | (≈0.5° divergence) | |
| Combination of Capillary and | ˜1000 | Yes (few deg) | Both | No |
| Shaped Grazing Incidence | | | | |

**Not all of this multiplication is usable because of beam size and divergence.

FIGS. 1-7 show several types of x-ray optical devices known in the art for x-ray crystallography, and Table 1 below summarizes key characteristics of each type. Other types of x-ray optics exist, but those shown here illustrate the basic principles and permit valid comparisons.

FIG. 1 is a plan view of a pinhole collimator 10 that can provide the x-ray optics for a diffraction crystallography system. An x-ray source 12 emits an x-ray beam 14 that is received by an entrance pupil 16 defining the pinhole of the collimator 10. The beam 14 propagates through the collimator 10 and exits through an exit pupil 18. The collimator 10 is typically a metal structure having suitable dimensions for crystallography.

The pinhole collimator 10 has been used widely in diffraction systems to collimate an x-ray beam, and is the standard of comparison for other types of x-ray optics. The entrance pupil 16 accepts a portion of the solid angle of x-ray emittance from the source 12. The diameter of the exit pupil 18 together with the distance from the source 12 establishes the beam 14 to have an acceptable size and divergence at the crystal location. A basic limitation of the pinhole collimator 10 is that in order to obtain a small beam with small divergence, the solid angle of acceptance of x-ray emittance from the source 12 is very small. For example, a pinhole collimator which produces a beam of 0.5 mm in diameter with a divergence angle of 1.0 milliradian (.057 degree) has a solid angle of acceptance of 7.85×10⁻⁷ steradians, compared to 12.57 steradians in a full sphere.

A second type of x-ray optics is shown in FIG. 2, and is referred to as a flat grazing incidence mirror 22. In this example, an x-ray beam 24 from an x-ray source 26 is incident on a reflective surface 28 of the mirror 22. The grazing incidence mirror 22 has a critical angle of incidence θ_{c}, such that if the angle of incidence of the x-ray beam 24 is less than the critical angle θ_{c}, the x-ray beam 24 will be reflected from the mirror surface 28 with almost no absorption. If, however, the angle of incidence is greater than θ_{c}, the x-ray beam 24 will be almost totally absorbed by the mirror material. The critical angle of incidence θ_{c} is a function of the x-ray wavelength and certain properties of the mirror material.

For copper K-alpha x-rays, the critical angle is on the order of 0.2° for typical mirror materials such as glass. Because this angle is about seven times greater than the cone half-angle of a pinhole collimator, a long planar mirror can collect more x-rays from the source 26 than the pinhole collimator. However, the flat mirror 22 reflects the beam 24 so that it fans out in a direction perpendicular to the plane of FIG. 2. Consequently, an assembly of mirrors must be used to capture and shape the reflected beam. The mirror assembly produces a beam which is more intense than the pinhole collimator, but the multiplication factor is not very large, and the beam emerging from the optics has a divergence which is a large fraction of the critical angle.

Often, grazing incidence mirrors are bent by mechanical devices into a desirable shape. FIG. 3 is a bent grazing incidence mirror 30 that also can be used as x-ray optics for a crystallography system. In this example, an x-ray beam 32 from a source 34 is reflected from a bent surface 36 of the mirror 30. Bending the mirror 30 tends to make the angle of incidence θ_{c} of the x-ray beam 32 constant along the length of the mirror 30, and this collimates the beam 32 in the plane of the figure. Focusing can also be provided by appropriately bending the mirror 30. Other mirrors in a concatenated optical chain assembly can collimate or focus the beam 32 in the direction perpendicular to the figure. Sometimes referred to as “double focusing mirrors”, such an assembly captures more x-rays from the source 34 than does a pinhole collimator, but the optical gain relative to the pinhole collimator usually is less than ten.

X-ray optics for crystallography systems have advanced beyond those optical devices discussed above for FIGS. 1-3. FIG. 4 shows an optical assembly 40 including a mirror 42 having an elliptically shaped surface 44 and a mirror 46 having a parabolic shaped surface 46. The assembly 40 is intended to represent part of two different x-ray optical assemblies, where the complete mirror 42 or 44 would be completely elliptical or completely parabolic, respectively. An x-ray beam 50 from a source 52 is directed towards both of the surfaces 44 and 48. In this example, the source 52 is placed at the focal point of the elliptical surface 44 and the parabolic surface 48. The shape of the elliptical surface 44 causes the x-ray beam 50 to be focused at a focal point 54. The elliptical shape of the surface 44 is such that the rays of the beam 50 gently converge at the focal point 54, and are thus suitable for crystallography. The sample being analyzed would be positioned at or near the focal point 54. For those crystallography applications that benefit from collimated light, the parabolic surface 48 converts the x-ray beam 50 to a collimated beam. Each mirror 42 and 48 operates on the grazing incidence principle. The x-ray beam 50 is incident on the mirror 44 and 46 at any angle less than the critical angle of incidence θ_{c}.

Shaped grazing incidence mirrors are very efficient at gathering x-rays. Optical gains exceeding 100 (compared to pinhole collimation) have been measured for this technology. Of course, the beam spreads out in a direction perpendicular to the plane of the figure, so that multiple mirrors are required to capture and collimate or focus the full beam.

Another type of advanced x-ray optics is a graded multilayer mirror 60 shown in FIG. 5. The graded multilayer mirror 60 operates on the principle of Bragg diffraction, rather than grazing incidence. A mirror substrate 62, typically glass, is layered with alternating high atomic number layers 64 and low atomic number layers 66. Many such layers are superimposed on the mirror substrate 62. FIG. 5 is intended only to illustrate the principle of operation of the graded multilayer mirror 0. An x-ray beam 68 incident on a top surface 70 of the mirror 60 is diffracted from the layers 64 and 66 at the angle θ. The thickness of the layers 64 and 66 is graded as a function of the distance along the mirror 60, because the incident angle of the x-ray beam 68 from an x-ray source varies with distance along the mirror 60. If the incident angle varies with distance, then the layer thickness must be varied in order to maintain the Bragg diffraction relationship for a constant wavelength, which is the desired wavelength for critical diffraction. The geometry of the layered mirror 60 is thus tailored to the crystal diffraction wavelength desired.

There are appreciable absorption losses in the graded multilayer mirror 60. The net reflectance for such a mirror is typically around 70 percent. Because of the trade-off between reflection and absorption in the layers 64 and 66, there is an optimum number of layers which maximizes the net reflectance, and for copper K-alpha x-rays, this optimum number has been estimated at between 100 and 200 layers.

The graded multilayer mirror 60 can be fabricated on shaped mirror substrates similar to those described above for the shaped grazing incidence mirror technology. Consequently, shaped multilayer mirrors can have the same x-ray gathering efficiency as shaped grazing incidence mirrors. However, the net reflectance of graded multilayer mirrors is lower than grazing incidence mirrors because of absorption in the layer structure. Of course, the mirrors are shaped to collimate or focus the x-ray beam.

Graded multilayer mirrors possess a very significant advantage compared to the other technologies. Because their operation is based on Bragg diffraction, graded multilayer mirrors can function as monochromators as well as x-ray gatherers and beam formers. If graded multilayer mirrors are used, no other monochromator device is needed in the optical chain, and the efficiency loss associated with that monochromator device is avoided. Consequently, the comparison of overall efficiency of the optical chain must take into account and the monochromator loss experienced if grazing incidence mirrors are used. Of course, with either technology the optical chain must use multiple mirrors to form the beam both in the plane of the figure and in the plane perpendicular to the figure, as described previously.

A third type of advanced x-ray optics is shown in FIGS. 6 and 7. This type of optics is referred to as capillary optics, also known as Kumakhov optics. FIG. 6 shows a single glass capillary 76 which accepts an x-ray beam 78 from a source 80. The x-ray beam 78 travels down the capillary 76 by multiple reflections from an inside surface of the glass wall. The critical angle of incidence governs the solid angle of acceptance of x-rays from the source 80, and for glass material, the critical angle θ_{c} is approximately 0.2 degree at the copper K-alpha wavelength. A simple calculation shows that, compared to a pinhole collimator which produces a beam 0.5 mm in diameter with a total divergence angle of 0.057 degree, the solid angle of acceptance of a 0.5 mm diameter single capillary is fourteen times greater than for the pinhole collimator. However, this optical gain is not completely realized. There are absorption losses as the x-ray beam 78 travels down the capillary 76 because the reflectance is not ideal and the inside surface of the capillary 76 is not perfectly smooth.

FIG. 6 illustrates a disadvantage suffered by capillary optics. The divergence angle of the beam 78 exiting the capillary 76 is two times the critical angle of incidence θ_{c} for the capillary 76. For glass material and copper K-alpha wavelength, this divergence angle is about 0.4 degree, which is about seven times the required limit of 0.057 degree.

FIG. 7 illustrates a polycapillary optical assembly 84 developed and marketed by X-Ray Optical Systems Inc., Albany, N.Y. Such an assembly can contain hundreds, or even thousands, of single capillaries 86. U.S. Pat. No. 5,570,408 discloses an x-ray optical system formed of a plurality of multiple-channel monolithic capillary optics of the type discussed herein. Because the capillaries 86 are flexible, the capillary assembly 84 can be formed as shown to have a focal point at the x-ray source 88 for the entrance beam 90, and to focus the exit beam at a second focal point where a sample 92 is positioned. The flexibility of the capillaries 86 will also allow the exit beam to be collimated if desired. The capillary assembly 84 can be shaped by mechanical clamps, and, once shaped, can be fused into a monolithic structure.

The polycapillary optical assembly has the largest x-ray gathering capability of all types of advanced x-ray optics. This is because the entrance aperture of the device can have many times the area, and hence the solid angle of acceptance, compared to any other device. At the entrance aperture, only a fraction (typically about half of the aperture area can gather x-rays because the glass walls of the capillaries 86 take up that fraction of the aperture area, and absorb the incident x-rays. The remaining fraction of the aperture area is composed of the tubes which accept and transmit x-rays. Within each capillary 86 there is also the transmission loss described above. However, the solid angle of acceptance of the polycapillary optic is enormous compared to all the other technologies, overwhelming the acceptance and transmission losses. In comparison with a pinhole collimator, exit beam optical gains of more than 1000 have been calculated (and substantiated by limited measurements) for the polycapillary optic.

For an application in x-ray diffraction systems, there are some serious limitations of polycapillary optics which effectively reduce the available optical gain. For example, the exit beam from the capillary assembly 84 has a convergence cone angle of several degrees at the sample location which is not usable for diffraction. To get a total convergence angle on the order of a milliradian requires blocking out most of the beam and using only the central milliradian. If the beam were collimated rather than focused, the diameter of the exit beam from the assembly 84 would be on the order of several millimeters. To obtain a beam with a diameter on the order of a millimeter at the sample location would again require blocking out most of the exit beam. Also, the resulting beam could have an unacceptably large divergence.

To summarize this discussion, the most important feasibility issue for x-ray crystallography has been to reduce the electrical power consumed by the x-ray source, while maintaining the x-ray beam characteristics (intensity, size, shape and crossfire) at levels at least equivalent to standard laboratory diffraction systems. Using advanced x-ray optics resolves this feasibility issue. An optical gain of about 40 can be used to reduce the electrical power dissipation in the x-ray source from a usual laboratory level of 4 kilowatts to 100 watts. Any of the three advanced x-ray optical technologies described above can achieve an optical gain exceeding 40, and probably more, making it possible to further increase beam intensity. Two of the three technologies can form the x-ray beam acceptably well. All three of the technologies are in an advanced state of development at the present time.

What is needed is an x-ray optical assembly for increasing the intensity of a formed x-ray beam that can be used in connection with, for example, an x-ray diffraction crystallography system, that provides a suitable optical gain of the x-ray beam for laboratory purposes, and also provides a suitable convergence or divergence angle of the x-ray beam on the sample It is therefore an object of the present invention to provide such an optical assembly.

### SUMMARY OF THE INVENTION

In accordance with the teachings of the present invention, an x-ray optical assembly is disclosed that provides increased x-ray beam intensity and a suitable sample convergence angle. Such an x-ray optical assembly has particular use for an x-ray diffraction crystallography system. The optical assembly includes a single capillary or polycapillary optical device and a mirror device configured and aligned to provide a desirable x-ray beam. An x-ray beam from an x-ray source enters the capillary optical device, where the beam intensity is increased. The beam exits the capillary optical device at a particular convergence angle, and is directed into the mirror device. The mirror device either focuses or collimates the beam to have a divergence angle suitable for the sample being analyzed. The mirror device can be any suitable device known in the art, such as an elliptical mirror device, a parabolic mirror device, or a graded multilayer mirror device.

Additional objects, advantages, and features of the present invention will become apparent from the following description and appended claims, taken in conjunction with the accompanying drawings.

### BRIEF DESCRIPTION OF THE DRAWINGS

FIG. 1 is a plan view of a pinhole collimator for use as an x-ray optical assembly in a crystallography system;

FIG. 2 is a plan view of a grazing incidence flat mirror for use as an x-ray optical assembly in a crystallography system;

FIG. 3 is a plan view of a grazing incidence bent mirror for use as an x-ray optical assembly in a crystallography system;

FIG. 4 is a plan view of a shaped grazing incidence mirror for use as an x-ray optical assembly in a crystallography system;

FIG. 5 is a graded multi-layer mirror for use as an x-ray optical assembly in a crystallography system;

FIG. 6 is a plan view of a single capillary for use as an x-ray optical assembly in a crystallography system;

FIG. 7 is a plan view of a polycapillary (also referred to as a polycapillary) optical system for use as an x-ray optical assembly in a crystallography system;

FIG. 8 is a plan view of an x-ray optical assembly that employs a polycapillary optical device and a shaped grazing incidence mirror device, according to an embodiment of the present invention; and

FIG. 9 is a plan view of an x-ray optical assembly that employs a single capillary optical device and a shaped grazing incidence mirror device, according to another embodiment of the present invention.

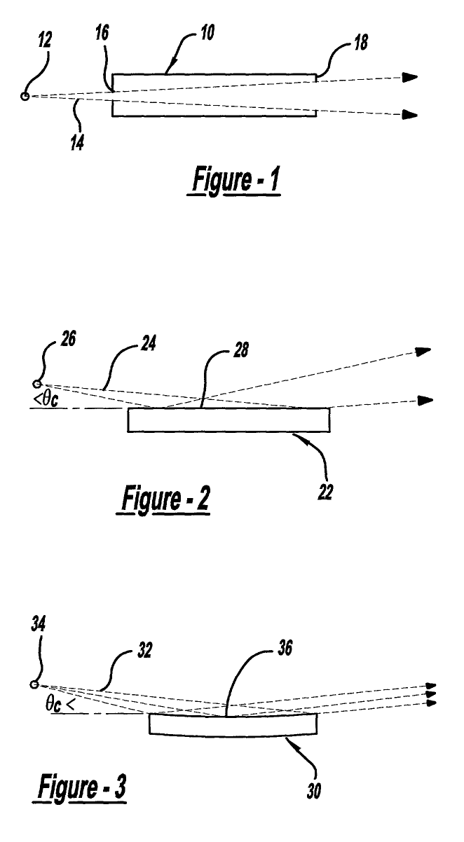

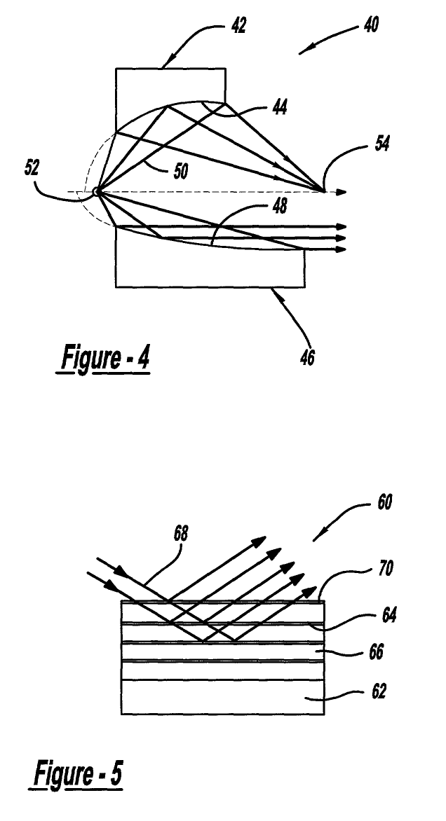

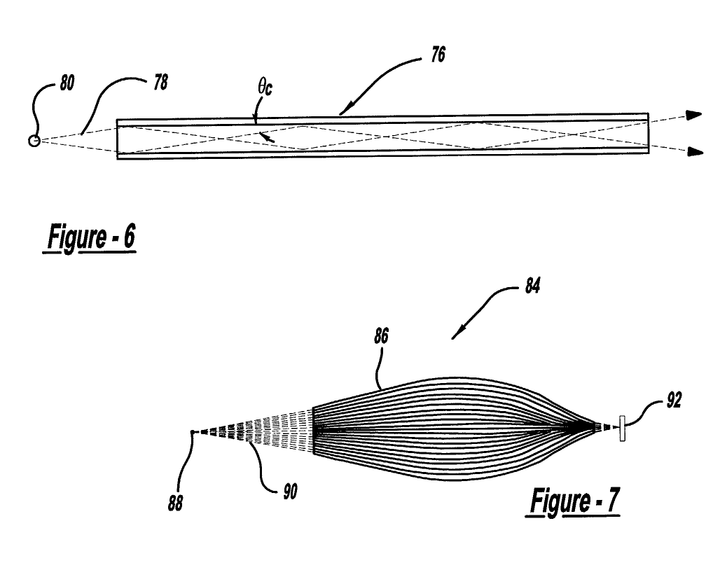

### DETAILED DESCRIPTION OF THE PREFERRED EMBODIMENT

The following discussion of the preferred embodiments directed to an x-ray optical assembly is merely exemplary in nature, and is in no way intended to limit the invention or its applications or uses. The principal application of this invention is x-ray diffraction of single crystals composed of protein macromolecules. However, the invention also has other applications that require a high intensity x-ray beam which is finally focused or collimated such that it has a very low divergence or convergence. Examples of other applications include single crystal x-ray diffraction; powder diffraction of x-rays for material characterization; x-ray fluorescence for characterization of thin films of materials layered on other material substrates; and medical applications; such as x-ray treatment of malignancies and x-ray tomography; x-ray microscopy; and non-destructive testing of various structures, including, but not limited to, microelectronic devices during manufacturing and packaging, liquid and solid materials, and mechanical assemblies, such as welded joints, machined surfaces, and structural objects.

The present invention combines two presently known optical devices into an optical assembly to provide a very substantial improvement in overall performance of the x-ray generating subsystem of, for example, a diffraction crystallography system. This is accomplished by improving both the number of x-rays from the source accepted by the optical assembly, and the ratio of usable x-rays in the diffraction beam to the number accepted. A redesign of the available optical devices will be necessary to optimize their integration into an assembly, but the current principles of operation and features of these devices from the prior art will not be changed.

While it is not practicable to use a polycapillary optical device alone to achieve a large optical gain for diffraction systems, it appears possible to use a combination of a polycapillary optical assembly together with one of the other known technologies to achieve a large optical gain having an acceptable beam characteristics. For example, if the capillary optical device were to focus the exit beam at the input focal point of a shaped grazing incidence mirror, the combined optical assembly could achieve the large optical gain of the polycapillary optical device together with the beam focusing or collimating capability of the shaped mirror.

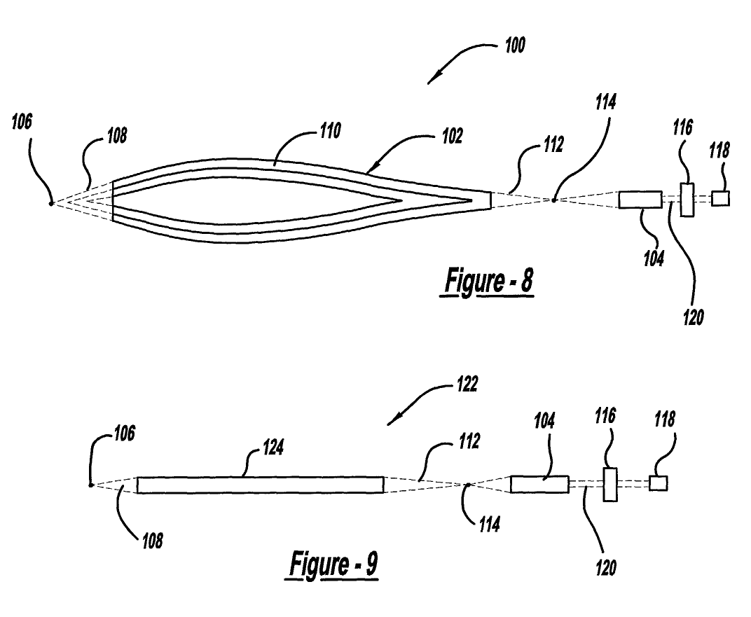

FIG. 8 is a plan view of an x-ray optical assembly 100 suitable for x-ray diffraction crystallography, according to an embodiment of the present invention. The assembly 100 includes a combination of a polycapillary optical device 102 and a shaped grazing incidence mirror device 104. The purpose of the optical assembly 100 is to accept x-ray photons from an x-ray source 106 and to form and shape a high intensity x-ray beam 108 with appropriate characteristics to be used in certain systems, such as an x-ray crystallography diffraction system. As discussed above, the polycapillary x-ray optical devices and the shaped grazing incidence mirror devices have been developed in the prior art and exist at the present time, although redesigns of both devices are anticipated to optimize the characteristics of the integrated optical assembly 100 of the invention.

The optical device 102 includes a plurality of individual capillaries 110. The individual capillaries 110 receive the x-ray beam 108 from the source 106, and generate an exit x-ray beam 112 at an output of the device 102, in the manner as discussed above, which is focused at a focal point 114. The mirror device 104 has a cylindrical shaped outer surface in one embodiment, and a specially configured inner reflective surface depending on the particular application. The inner surface of the mirror 104 can be elliptical shaped to provide a slow converging beam, or parabolic shaped to provide a collimated beam, as is also discussed above. Other shapes may also be applicable. In an alternate embodiment, the mirror 104 can be any of the grazing incidence mirrors or the graded multilayer mirror discussed above. The mirror 104 is positioned relative to the focal point 114 so that the entrance aperture of the mirror 104 receives the beam 112 in a desirable manner. A beam 120 exiting the mirror 104 is directed through a monochromator 116 that filters the beam 120 to the desired wavelength. In those applications where the mirror 104 is a multilayer mirror, the monochromator 116 can be eliminated. The filtered beam 120 then impinges a sample 118 being analyzed. The detection and processing device of the crystallography system are not shown.

Designing the optical assembly 100 of the invention involves optimizing the separate components for optical mating and physical assembly. Ideally, the intensity gain of the polycapillary optical device 102 is the intensity gain of the overall assembly 100 because the exit beam 112 from the polycapillary device 102 enters and is completely processed by the mirror device 104. This is not true in practice because the exit beam 112 has an inherent divergence of 3.5 milliradians (half-angle), so the mirror device 104 must be designed to accommodate the exit beam characteristics of the polycapillary device 102 as closely as possible.

As described above, the gain of the polycapillary device 102 is inherently high because the acceptance cone can be made very large by shaping and sizing this optical component. The shape and size of the polycapillary device 102 will be limited by forming the exit beam 112 to match the acceptance cone of the mirror device 104. Also, there are significant transmission losses within the polycapillary device 102 because of absorption within the material (usually glass) of the capillary walls around and between the individual capillaries 110, and there is absorption within the capillaries 110, principally due to surface roughness. The polycapillary optical design problem is to maximize its acceptance cone consistent with the characteristics of the mirror component, and then to choose the optimal size versus the number of capillaries 100 that fit within the resulting size and shape envelopes to minimize transmission losses through the device 102. Information from and coordination with a chosen polycapillary device supplier will be necessary for the design.

The mirror device design problem is to optimize its acceptance cone, and the separation distance between the device 102 and the device 104, consistent with characteristics of the exit beam 112, so that the maximum number of x-rays from the polycapillary device 102 are processed by the mirror device 104 to form a focused or the collimated beam 120. The design of the components must be carried out simultaneously in order to optimize the intensity gain and beam characteristics of the coupled optical assembly 100.

The optical assembly 100 will be designed, in one example, for application in a single crystal x-ray diffraction system for use in protein crystallography. The anticipated beam characteristics at the target crystal location include the following:

High beam intensity (flux)—10⁹ to 10¹¹ x-rays per square millimeter per second within the beam cross section;

Very small beam divergence/convergence angle—less than 1 milliradian cone half-angle;

Small beam cross sectional diameter—on the order of 1.0 millimeter;

Monochromatic x-ray wavelength—copper K alpha x-rays at 1.5418 Angstroms wavelength.

As discussed above, the combination of the optical device 102 and the mirror device 104 would be optimized for a particular application. In one example, the mirror device 104 has an entrance pupil of 0.45 millimeter in diameter and is located 12.5 millimeters from the focal point 114. The mirror device 104 has an acceptance cone with a half-angle of 18.0 milliradians and solid angle of acceptance of 1.018 ×10⁻³ steradians. If there were no losses within the mirror device 104, it would have an optical gain of 1296 compared to a pinhole collimator with a total divergence angle of 1.0 milliradian (acceptance cone half-angle of 0.5 milliradian). Of course, losses do occur in the mirror 104, but an optical gain of several hundred is likely.

The design objective for the polycapillary optical device 102 is to form a beam which focuses at the focal point of the mirror device 104, has a convergency half-angle of 18 milliradians, and contains the maximum flux within that cone. If, the exit aperture of the polycapillary optical device 102 has a diameter of 6.0 millimeters, then the polycapillary exit aperture is located about 180 millimeters (7.1 inches) from the entrance pupil of the mirror device 104. This separation distance is entirely reasonable for the protein crystallography application.

The exit beam 112 from the polycapillary optical device 102 will contain the maximum x-ray flux if the acceptance cone of the device 102 is maximized by design techniques to be consistent with its exit aperture. An optical transfer gain through this device [ratio of input solid angle of acceptance to output solid angle of convergency, times the transfer efficiency (approximately 0.4)] of about 50 should be achievable. When this is multiplied by the optical gain of the mirror device 104, the overall gain of the optical assembly 100 should be well over 1000, compared to the pinhole collimator. This in turn should produce a beam from the optical assembly 100 which has a flux greater than 1010 x-rays per square millimeter per second, and a total convergence angle of 1.0 milliradian.

FIG. 9 shows a plan view of an x-ray optical assembly 122, according to another embodiment of the present invention. The assembly 122 is similar to the optical assembly 100 discussed above, where like reference numerals represent the same components. As discussed above, the optical assembly 100 includes a polycapillary optical device 102. In an alternate design, the polycapillary optical device 102 can be replaced with a single capillary device 124. In this design, the single capillary optical device 124 offers a less complex device, but does not provide as high an intensity x-ray beam as the optical device 102. Further, in this embodiment, the optical device 124 is shown as a cylindrical capillary device, but as will be appreciated by those skilled in the art, the device 124 can be a tapered capillary device.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. An x-ray optical assembly comprising:
an optical device including at least one optical capillary receiving an x-ray beam, said optical device increasing the intensity of the x-ray beam and focusing the x-ray beam; and
a mirror device responsive to the focused x-ray beam from the optical device, said mirror device forming the focused x-ray beam into a formed x-ray beam.

2. The assembly according to claim 1 wherein the mirror device is selected from the group consisting of grazing incidence flat mirror devices, grazing incidence bent mirror devices, grazing incidence shaped mirror devices, and graded multilayer mirror devices.

3. The assembly according to claim 2 wherein the mirror device is a bent or shaped grazing incidence mirror device having a reflective surface selected from the group consisting of elliptical surfaces and parabolic surfaces.

4. The assembly according to claim 1 wherein the mirror device has a cylindrical profile about a central axis in the direction of the formed beam exiting from the mirror device.

5. The assembly according to claim 1 wherein the optical device is a polycapillary optical device including a plurality of optical capillaries each receiving the x-ray beam.

6. The assembly according to claim 1 wherein the optical device only includes a single optical capillary receiving the x-ray beam.

7. The assembly according to claim 1 further comprising a monochromator, said monochromator receiving the formed beam from the mirror device and filtering the formed beam to a single x-ray wavelength.

8. The assembly according to claim 1 wherein the at least one optical capillary focuses the x-ray beam at a focal point in front of the mirror device.

9. The assembly according to claim 1 wherein the mirror device is optically coupled to the optical device in a manner that maximizes the intensity of the x-ray beam formed by the mirror device.

10. The assembly according to claim 1 wherein the at least one capillary is made of glass and a surface of the mirror device is made of an x-ray reflective material.

11. The assembly according to claim 1 wherein the assembly is part of an x-ray diffraction crystallography system.

12. An x-ray assembly for use in a system requiring a high intensity, finely focused or collimated x-ray beam having a very low convergent or divergent angle, said assembly comprising:
an x-ray source generating an x-ray beam;
a capillary optical device including at least one optical capillary receiving the x-ray beam, said optical device increasing the intensity of the x-ray beam and focusing the x-ray beam; and
a mirror device responsive to the focused x-ray beam from the optical device, said optical device focusing the x-ray beam near an entrance pupil of the mirror device, said mirror device forming the focused x-ray beam into a finely focused or collimated x-ray beam effective for a predetermined application.

13. The assembly according to claim 12 wherein the mirror device is selected from the group consisting of grazing incidence flat mirror devices, grazing incidence bent mirror devices, grazing incidence shaped mirror devices and graded multilayer mirror devices.

14. The assembly according to claim 13 wherein the mirror device is a grazing incidence shaped mirror device having a reflective surface selected from the group consisting of elliptical surfaces and parabolic surfaces.

15. The assembly according to claim 12 wherein the mirror device has a cylindrical profile about a central axis in the direction of the formed beam exiting from the mirror device.

16. The assembly according to claim 12 wherein the capillary optical device is a polycapillary optical device including a plurality of optical capillaries each receiving the x-ray beam.

17. The assembly according to claim 12 wherein the capillary optical device only includes a single optical capillary receiving the x-ray beam.

18. The assembly according to claim 12 further comprising a monochromator, said monochromator receiving the formed beam from the mirror device and filtering the formed beam to a single x-ray wavelength.

19. The assembly according to claim 12 wherein the mirror device is optically coupled to the optical device in a manner that maximizes the intensity of the x-ray beam formed by the mirror device.

20. The assembly according to claim 12 wherein the capillary optical device is made of glass and a surface of the mirror device is made of an x-ray reflective material.

21. A method of forming an x-ray beam, said method comprising the steps of:
generating an x-ray beam;
directing the x-ray beam into an optical device including at least one optical capillary;
increasing the intensity of a focused x-ray beam exiting from the optical device;
directing the focused x-ray beam onto a mirror device; and
forming the focused x-ray beam by the mirror device.

22. The method according to claim 21 wherein the step of directing the x-ray beam into an optical device includes directing the x-ray beam into an optical device including a plurality of capillaries.

23. The method according to claim 21 wherein the step of directing the x-ray beam into an optical device includes directing the x-ray beam into an optical device including only a single capillary.

24. The method according to claim 21 wherein the step of directing the focused x-ray beam onto a mirror device includes directing the x-ray beam onto a mirror device selected from the group consisting of grazing incidence flat mirror devices, grazing incidence bent mirror devices, grazing incidence shaped mirror devices and graded multilayer mirror devices.

25. The method according to claim 24 wherein the step of directing the focused x-ray beam onto a mirror device includes directing the x-ray beam onto a grazing incidence bent mirror device or a grazing incidence shaped mirror device having a reflected surface selected from the group consisting of elliptical surfaces and parabolic surfaces.

26. The method according to claim 21 wherein the step of focusing the x-ray beam includes focusing the x-ray beam at a focal point in front of the mirror device.

27. The method according to claim 21 wherein the steps of increasing the intensity and focusing the x-ray beam and forming the focused x-ray beam include optically coupling the mirror device to the optical device in a manner that maximizes the intensity of the x-ray beam formed by the mirror device.
